(19) United States
(12) Patent Application Publication
(10) Pub. No.: US 2010/0153890 A1
(43) Pub. Date: Jun. 17, 2010

(54) Method, Apparatus and Computer Program Product for Providing a Predictive Model for Drawing Using Touch Screen Devices

(75) Inventors: Hao Wang, Beijing (CN); Kun Wu, Beijing (CN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/332,675

(22) Filed: Dec. 11, 2008

(51) Int. Cl. G06F 3/033

(52) U.S. Cl. 715/863

(57) ABSTRACT

An apparatus for providing a predictive model for use with touch screen devices may include a processor. The processor may be configured to identify a stroke event received at a touch screen display, evaluate an environmental parameter corresponding to the touch screen display to determine a scenario based on the environmental parameter, and generate a graphic output corresponding to the identified stroke event for the scenario determined. A corresponding method and computer program product are also provided.

### TECHNOLOGICAL FIELD

Embodiments of the present invention relate generally to user interface technology and, more particularly, relate to a method, apparatus, and computer program product for providing a predictive model for drawing using touch screen devices.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

In many situations, it may be desirable for the user to interface with a device such as a mobile terminal for the provision of an application or service. A user's experience during certain applications such as, for example, web browsing or applications that enable drawing may be enhanced by using a touch screen display as the user interface. Furthermore, some users may have a preference for use of a touch screen display for entry of user interface commands or simply creating content over other alternatives. In recognition of the utility and popularity of touch screen displays, many devices, including some mobile terminals, now employ touch screen displays. As such, touch screen devices are now relatively well known, with numerous different technologies being employed for sensing a particular point at which an object may contact the touch screen display.

### BRIEF SUMMARY

A method, apparatus and computer program product are therefore provided for providing a predictive model for use with touch screen devices. In particular, a method, apparatus and computer program product are provided that enable users of devices with touch screens to generate visual content relatively quickly and easily by providing predictive functionality that may be of particular use in small display environments. However, the advantages of the predictive model disclosed herein may also be realized in other environments including large screen environments as well.

In one exemplary embodiment, a method of providing a predictive model for use with touch screen devices is provided. The method may include identifying a stroke event received at a touch screen display, evaluating an environmental parameter corresponding to the touch screen display to determine a scenario based on the environmental parameter, and generating a graphic output corresponding to the identified stroke event for the scenario determined.

In another exemplary embodiment, a computer program product for providing a predictive model for use with touch screen devices is provided. The computer program product includes at least one computer-readable storage medium having computer-executable program code instructions stored therein. The computer-executable program code instructions may include program code instructions for identifying a stroke event received at a touch screen display, evaluating an environmental parameter corresponding to the touch screen display to determine a scenario based on the environmental parameter, and generating a graphic output corresponding to the identified stroke event for the scenario determined.

In another exemplary embodiment, an apparatus for providing a predictive model for use with touch screen devices is provided. The apparatus may include a processor configured to identify a stroke event received at a touch screen display, evaluate an environmental parameter corresponding to the touch screen display to determine a scenario based on the environmental parameter, and generate a graphic output corresponding to the identified stroke event for the scenario determined.

In another exemplary embodiment, an apparatus for providing a predictive model for use with touch screen devices is provided. The apparatus includes means for identifying a stroke event received at a touch screen display, means for evaluating an environmental parameter corresponding to the touch screen display to determine a scenario based on the environmental parameter, and means for generating a graphic output corresponding to the identified stroke event for the scenario determined.

Embodiments of the invention may provide a method, apparatus and computer program product for improving touch screen interface performance. As a result, for example, mobile terminal users may enjoy improved capabilities with respect to services or applications that may be used in connection with a touch screen display.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a system according to an exemplary embodiment of the present invention;

FIG. 2 is a schematic block diagram of an apparatus for providing a predictive model for use with touch screen devices according to an exemplary embodiment of the present invention;

FIG. 3 shows an example of operation of the apparatus of FIG. 2 according to an exemplary embodiment of the present invention;

FIG. 4 illustrates a flow diagram of an example operation of an alternative exemplary embodiment of the present invention;

FIG. 5 (including FIGS. 5A through 5G) shows examples of associations between particular stroke events and corresponding graphic outputs that may be provided by exemplary embodiments of the present invention in order to modify a drawing;

FIG. 6 shows an example of operation of the apparatus of FIG. 2 according to yet another exemplary embodiment of the present invention; and

FIG. 7 is a block diagram according to an exemplary method for providing a predictive model for use with touch screen devices according to an exemplary embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

In certain environments, such as when used in connection with a mobile terminal or other device having a relatively small display, it may be difficult to provide drawn inputs to a touch screen with a reasonable level of accuracy or resolution, even if using a stylus instead of a finger as the drawing implement. Accordingly, it may be desirable to provide a mechanism for improving user experience in connection with drawing on a touch screen.

As indicated above, some embodiments of the present invention may improve touch screen interface performance by providing a predictive model for assisting in recognition of contextual and/or environmental conditions in order to enable characterization of the current scenario in which the touch screen interface is being operated. Based on the conditions sensed and the scenario determined, a predictive model may be created and/or updated. The predictive model may then be employed along with inputs received by the touch screen interface, in order to generate an output in the form of a drawing, pattern, symbol or other associated graphic output.

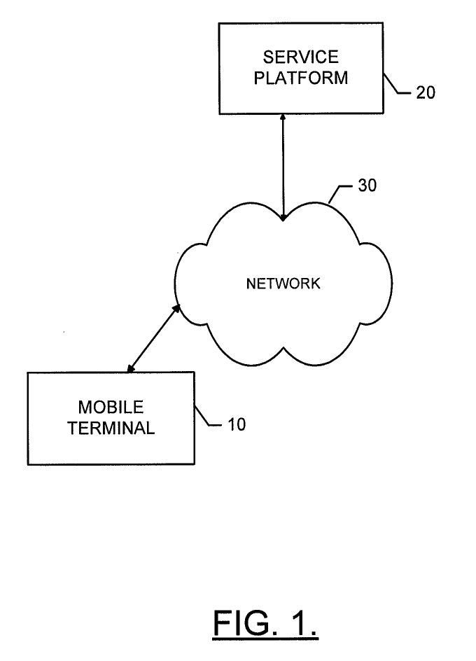

FIG. 1 illustrates a block diagram of a system that may benefit from embodiments of the present invention. It should be understood, however, that the system as illustrated and hereinafter described is merely illustrative of one system that may benefit from embodiments of the present invention and, therefore, should not be taken to limit the scope of embodiments of the present invention. As shown in FIG. 1, an embodiment of a system in accordance with an example embodiment of the present invention may include a mobile terminal 10 capable of communication with numerous other devices including, for example, a service platform 20 via a network 30. In some embodiments of the present invention, the system may further include one or more additional devices such as personal computers (PCs), servers, network hard disks, file storage servers, and/or the like, that are capable of communication with the mobile terminal 10 and accessible by the service platform 20. However, not all systems that employ embodiments of the present invention may comprise all the devices illustrated and/or described herein. Moreover, in some cases, embodiments may be practiced on a standalone device independent of any system.

The mobile terminal 10 may be any of multiple types of mobile communication and/or computing devices such as, for example, portable digital assistants (PDAs), pagers, mobile televisions, mobile telephones, gaming devices, laptop computers, cameras, camera phones, video recorders, audio/video player, radio, GPS devices, or any combination of the aforementioned, and other types of voice and text communications systems. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), e.g., the Internet. In turn, other devices such as processing elements (e.g., personal computers, server computers or the like) may be included in or coupled to the network 30. By directly or indirectly connecting the mobile terminal 10 and the other devices (e.g., service platform 20, or other mobile terminals) to the network 30, the mobile terminal 10 and/or the other devices may be enabled to communicate with each other, for example, according to numerous communication protocols, to thereby carry out various communication or other functions of the mobile terminal 10 and the other devices, respectively. As such, the mobile terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi (Wireless Fidelity), ultra-wide band (UWB), Wibree techniques and/or the like and fixed access mechanisms such as digital subscriber line (DSL), cable modems, Ethernet and/or the like.

In an example embodiment, the service platform 20 may be a device or node such as a server or other processing element. The service platform 20 may have any number of functions or associations with various services. As such, for example, the service platform 20 may be a platform such as a dedicated server (or server bank) associated with a particular information source or service (e.g., a drawing support service), or the service platform 20 may be a backend server associated with one or more other functions or services. As such, the service platform 20 represents a potential host for a plurality of different services or information sources. In some embodiments, the functionality of the service platform 20 is provided by hardware and/or software components configured to operate in accordance with known techniques for the provision of information to users of communication devices. However, at least some of the functionality provided by the service platform 20 may be data processing and/or service provision functionality provided in accordance with embodiments of the present invention.

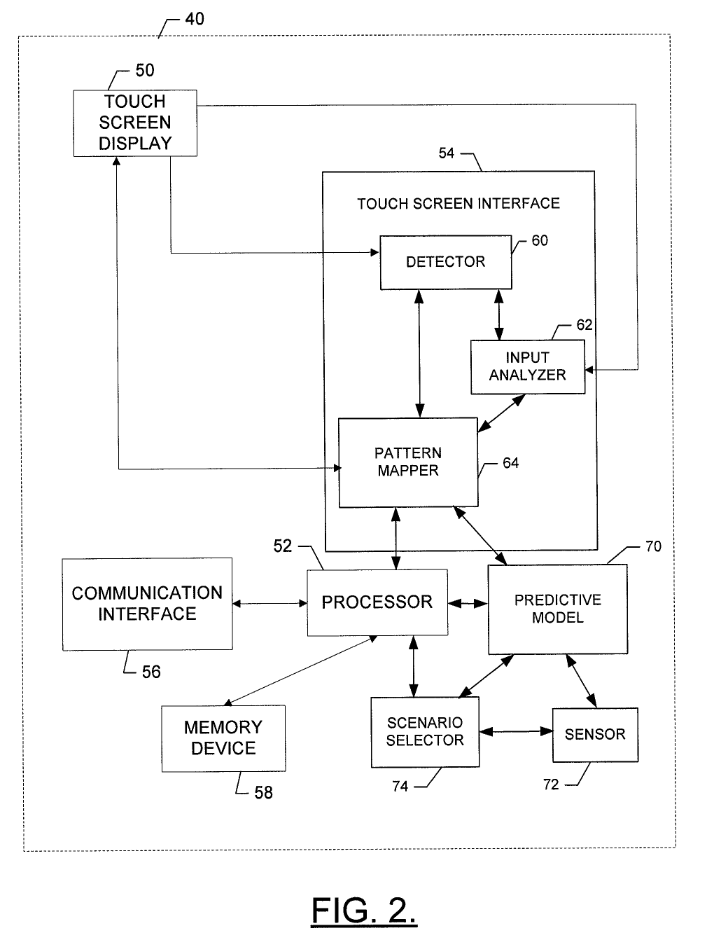

FIG. 2 illustrates a block diagram of an apparatus that may benefit from embodiments of the present invention. It should be understood, however, that the apparatus as illustrated and hereinafter described is merely illustrative of one apparatus that may benefit from embodiments of the present invention and, therefore, should not be taken to limit the scope of embodiments of the present invention. In one exemplary embodiment, the apparatus of FIG. 2 may be employed on a mobile terminal (e.g., mobile terminal 10) capable of communication with other devices via a network. However, in some cases, the apparatus on which embodiments of the present invention are practiced may be a fixed terminal and/or a terminal that does not communicate with other devices. As such, not all systems that may employ embodiments of the present invention are described herein. Moreover, other structures for apparatuses employing embodiments of the present invention may also be provided and such structures may include more or less components than those shown in FIG. 2. Thus, some embodiments may comprise more or less than all the devices illustrated and/or described herein. Furthermore, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 2, an apparatus for employing a predictive model for drawing assistance on a touch screen display is provided. The apparatus 40 may include or otherwise be in communication with a touch screen display 50, a processor 52, a touch screen interface 54, a communication interface 56 and a memory device 58. The memory device 58 may include, for example, volatile and/or non-volatile memory. The memory device 58 may be configured to store information, data, applications, instructions or the like for enabling the apparatus to carry out various functions in accordance with exemplary embodiments of the present invention. For example, the memory device 58 could be configured to buffer input data for processing by the processor 52. Additionally or alternatively, the memory device 58 could be configured to store instructions for execution by the processor 52. As yet another alternative, the memory device 58 may be one of a plurality of databases or storage locations that store information and/or media content.

The processor 52 may be embodied in a number of different ways. For example, the processor 52 may be embodied as various processing means such as a processing element, a coprocessor, a controller or various other processing devices including integrated circuits such as, for example, an ASIC (application specific integrated circuit), an FPGA (field programmable gate array), a hardware accelerator, or the like. In an exemplary embodiment, the processor 52 may be configured to execute instructions stored in the memory device 58 or otherwise accessible to the processor 52. As such, whether configured by hardware or software methods, or by a combination thereof, the processor 52 may represent an entity capable of performing operations according to embodiments of the present invention while configured accordingly.

Meanwhile, the communication interface 56 may be any means such as a device or circuitry embodied in either hardware, software, or a combination of hardware and software that is configured to receive and/or transmit data from/to a network and/or any other device or module in communication with the apparatus 40. In this regard, the communication interface 56 may include, for example, an antenna (or multiple antennas) and supporting hardware and/or software for enabling communications with a wireless communication network. In fixed environments, the communication interface 56 may alternatively or also support wired communication. As such, the communication interface 56 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 56 may include hardware and/or software for supporting communication mechanisms such as Bluetooth, Infrared, ultra-wideband (UWB), WiFi, and/or the like.

The touch screen display 50 may be embodied as any known touch screen display. Thus, for example, the touch screen display 50 could be configured to enable touch recognition by any suitable technique, such as resistive, capacitive, infrared, strain gauge, surface wave, optical imaging, dispersive signal technology, acoustic pulse recognition, or other like techniques. The touch screen interface 54 may be in communication with the touch screen display 50 to receive indications of user inputs at the touch screen display 50 and to modify a response to such indications based on corresponding user actions that may be inferred or otherwise determined responsive to the indications. In this regard, the touch screen interface 54 may be any device or means embodied in either hardware, software, or a combination of hardware and software configured to perform the respective functions associated with the touch screen interface 54 as described below. In an exemplary embodiment, the touch screen interface 54 may be embodied in software as instructions that are stored in the memory device 58 and executed by the processor 52. Alternatively, touch screen interface 54 may be embodied as the processor 52 configured to perform the functions of the touch screen interface 54.

The touch screen interface 54 may be configured to receive an indication of an input in the form of a touch event at the touch screen display 50. Following recognition of the touch event, the touch screen interface 54 may be configured to thereafter determine a stroke event or other input gesture and provide a corresponding indication on the touch screen display 50 based on the stroke event. In this regard, for example, the touch screen interface 54 may include a detector 60 to receive indications of user inputs in order to recognize and/or determine a touch event based on each input received at the detector 60.

A touch event may be defined as a detection of an object, such as a stylus, finger, pen, pencil or any other pointing device, coming into contact with a portion of the touch screen display in a manner sufficient to register as a touch. In this regard, for example, a touch event could be a detection of pressure on the screen of touch screen display 50 above a particular pressure threshold over a given area. Subsequent to each touch event, the touch screen interface 54 (e.g., via the detector 60) may be further configured to recognize and/or determine a corresponding stroke event or input gesture. A stroke event (which may also be referred to as an input gesture) may be defined as a touch event followed immediately by motion of the object initiating the touch event while the object remains in contact with the touch screen display 50. In other words, the stroke event or input gesture may be defined by motion following a touch event thereby forming a continuous, moving touch event defining a moving series of instantaneous touch positions. The stroke event or input gesture may represent a series of unbroken touch events, or in some cases a combination of separate touch events. For purposes of the description above, the term immediately should not necessarily be understood to correspond to a temporal limitation. Rather, the term immediately, while it may generally correspond to relatively short time after the touch event in many instances, instead is indicative of no intervening actions between the touch event and the motion of the object defining the touch positions while such object remains in contact with the touch screen display 50. However, in some instances in which a touch event that is held for a threshold period of time triggers a corresponding function, the term immediately may also have a temporal component associated in that the motion of the object causing the touch event must occur before the expiration of the threshold period of time.

In an exemplary embodiment, the detector 60 may be configured to communicate detection information regarding the recognition or detection of a stroke event or input gesture to an input analyzer 62 and/or a pattern mapper 64. In some embodiments, the input analyzer 62 and the pattern mapper 64 may each (along with the detector 60) be portions of the touch screen interface 54. Furthermore, each of the input analyzer 62 and the pattern mapper 64 may be embodied as any means such as a device or circuitry embodied in hardware, software or a combination of hardware and software that is configured to perform corresponding functions of the input analyzer 62 and the pattern mapper 64, respectively.

In this regard, for example, the input analyzer 62 may be configured to compare an input gesture or stroke event to various profiles of previously received input gestures and/or stroke events in order to determine whether a particular input gesture or stroke event corresponds to a known or previously received input gesture or stroke event. If a correspondence is determined, the input analyzer 62 may identify the recognized or determined input gesture or stroke event to the pattern mapper 64. In some embodiments, the input analyzer 62 is configured to determine stroke or line orientations (e.g., vertical, horizontal, diagonal, etc.) and various other stroke characteristics such as length, curvature, shape, and/or the like. The determined characteristics may be compared to characteristics of other input gestures either of this user or generic in nature, to determine or identify a particular input gesture or stroke event based on similarity to known input gestures.

In general terms, the pattern mapper 64 may be configured to map recognized input gestures or stroke events to corresponding stored patterns to which each recognized input gesture or stroke event (or selected ones) is associated. Thus, the pattern mapper 64 may provide a completed pattern, symbol, drawing, graphic, animation or other graphical output to be associated with a corresponding one or more input gestures or stroke events. In an exemplary embodiment, however, the pattern mapper 64 may further enable associations between specific ones of the input gestures or stroke events and corresponding specific completed patterns, symbols, drawings, animations, graphics or other graphical outputs based on input also from a predictive model 70. The predictive model 70 may provide differentiation between different graphical outputs that may be associated with the same gesture or stroke event. Thus, for example, although the same stroke event may be associated with a plurality of different patterns, the predictive model 70 may enable the pattern mapper 64 to distinguish between which associated specific pattern among the plurality of different patterns is to be associated with a detected instance of the stroke event based on the situation in which the stroke event was received. In other words, the predictive model 70 may be configured to provide a situational awareness capability to the pattern mapper 64 based on the current scenario.

The predictive model 70, in some cases, is a component of the touch screen interface 54. More specifically, in some cases, the predictive model 70 may be a module or other component portion of the pattern mapper 64. However, in some alternative embodiments (as shown in the example of FIG. 2), the predictive model 70 may be a separate device. In any case, the predictive model 70 may record (e.g., in the memory device 58 or in another database or storage location) information indicating which of a plurality of potential graphical outputs are associated with a respective input gesture or stroke event. As such, in some embodiments, the predictive model 70 may receive information from various devices and/or sensors that may enable the predictive model 70 (or the pattern mapper 64) to determine the current situation or scenario.

In an exemplary embodiment, one or more sensors (e.g., sensor 72) and/or a scenario selector 74 may be included as portions of the pattern mapper 64 or may be in communication with the pattern mapper 64. The sensors may be any of various devices or modules configured to sense a plurality of different environmental and/or contextual conditions. In this regard, for example, conditions that may be monitored by the sensor 72 may include time, location, emotion, weather, speed, people nearby, temperature, people and/or devices nearby, pressure (e.g., an amount of pressure exerted by a touch event), and other parameters. As such, the sensor 72 could represent one of a plurality of separate devices for determining any of the above factors (e.g., a thermometer for providing temperature information, a clock or calendar for providing temporal information, a GPS device for providing speed and/or location information, etc.) or the sensor 72 may represent a combination of devices and functional elements configured to determine corresponding parameters (e.g., a thermometer and heart rate monitor for determining emotion according to an algorithm for providing emotional information, a web application for checking a particular web page for weather information at a location corresponding to the location of the apparatus 40 as provided by a GPS device, a Bluetooth device or camera for determining nearby devices or people, a pressure sensor associated with the detector 60, etc.).

The scenario selector 74 may be any means such as a device or circuitry embodied in hardware, software or a combination of hardware and software that is configured to perform corresponding functions of the scenario selector 74 as described herein. In this regard, for example, the scenario selector 74 may be configured to receive sensor information from the sensor 72, and in some cases user input, to determine (or otherwise predict) a scenario corresponding to the current conditions sensed at the apparatus 40. Thus, for example, the scenario selector 74 may utilize predefined situational information input by a user to define situations, or the scenario selector 74 may be configured to learn and classify situations based on user behavior under certain conditions. For example, a particular time of day coupled with a specific location may have a corresponding scenario associated therewith. For example, during working hours on a weekday when the user is at a GPS location corresponding to the user's workplace, the scenario may be defined as “at work”. Meanwhile, at a time after working hours or on a weekend, when the user is at a GPS location corresponding to the user's house, the scenario may be defined as “at home”. As yet another example, additional factors such as date, temperature, weather and people nearby may be useful in defining other scenarios such as scenarios corresponding to parties, holiday celebrations, leisure activities, meetings, and many others.

In some cases, the user may provide amplifying information or directly select factors or the scenario itself. For example, the user may select a mood or emotion such as “blue”, when the user is feeling sad, or “excited” when the user is eagerly anticipating an upcoming event. The mood may define the scenario or may be used as a factor in selecting the scenario along with other information. Furthermore, in some cases the scenario may be randomly selected, or a random scenario may itself be defined so that associations made between a stroke event detected from the user and the pattern displayed may be randomly determined to produce a potential for amusing results.

In an exemplary embodiment, the predictive model 70 may include associations determined based on a built up library of drawings completed by the user. In this regard, for example, while the user is working on a drawing, the scenario selector 74 may utilize information from the sensor 72 to determine the current situation and record an association between the drawing made, the stroke event or input gesture used to initiate the drawing, and the scenario in which the drawing was created. As an alternative, the user may define associations between a library of previously completed, stored or downloaded graphical outputs (e.g., drawings) and various different stroke events or input gestures. As yet another alternative, a predetermined library of graphical outputs and corresponding stroke events may be utilized. In some cases, the predetermined library may be stored at or otherwise provided by the service platform 20. Moreover, in some cases, portions of the apparatus 40 (e.g., the pattern mapper 64) could be embodied at the service platform 20 and embodiments of the present invention could be practiced in a client/server environment. In some embodiments, combinations of the alternatives above may be employed. Thus, for example, an initial library may exist and the user may modify the library either comprehensively or piecemeal over time. Thus, the predictive model 70 may employ predetermined and/or learned knowledge associated with providing the pattern mapper 64 with situational awareness capabilities.

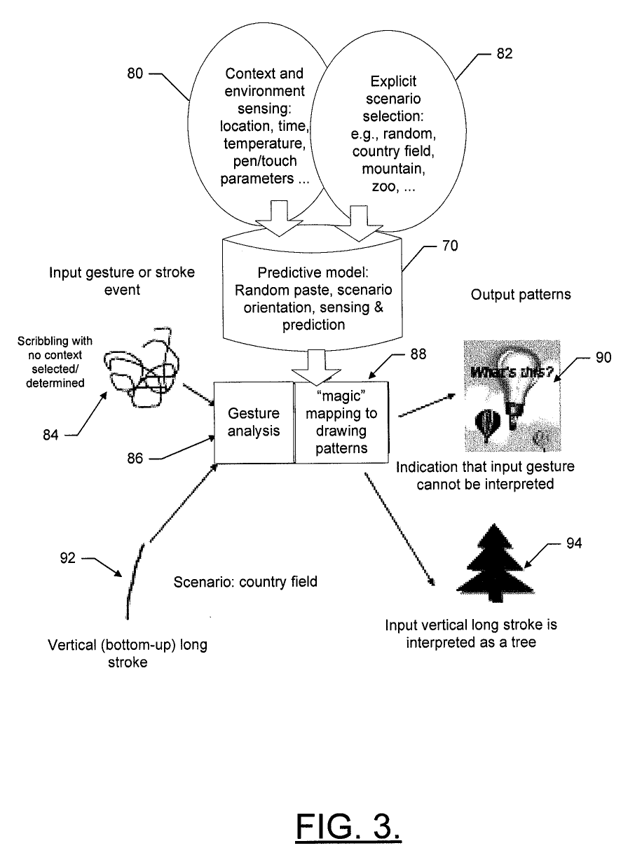

FIG. 3 shows an example of operation of the apparatus 40 of FIG. 2 according to one embodiment. In this regard, as shown in FIG. 3, context and environmental sensing inputs (e.g., from the sensor 72) 80 may be received by the predictive model 70 along with a scenario selection 82. Meanwhile, an input gesture (in one example, some scribbling) 84 may be received for gesture analysis 86 (e.g., by the input analyzer 62 of the touch screen interface 54). In this example, no context may be selected or otherwise determinable, so mapping operation 88 (e.g., via the pattern mapper 64) may not be able to determine a corresponding graphical output. As such, for example, an indication of the failure of the mapping operation may be provided as shown by graphic 90. Meanwhile, in an alternative example in which a stroke event 92 is received in a context in which the scenario was selected as “country field” by the sensor 72, the gesture analysis 86 may recognize the vertical (bottom-up) long stroke and the mapping operation 88 may employ the predictive model 70 for the selected scenario to determine a tree 94 as the corresponding output graphic.

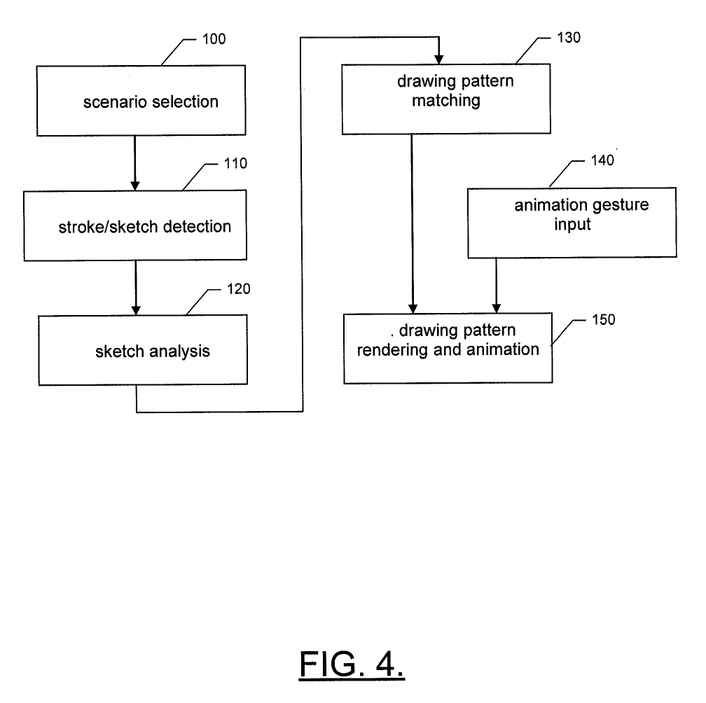

FIG. 4 illustrates a flow diagram of an example operation of an alternative exemplary embodiment of the present invention. In this regard, as shown in FIG. 4, a predictive drawing application according to an exemplary embodiment includes an initial operation 100 of scenario selection. In scenario selection (e.g., via the scenario selector 74), the apparatus may sense the environment (e.g., via the sensor 72) and determine or select a suitable scenario using a “scenario classifier” algorithm based on the sensed environmental parameters such as location, speed, temperature, time, emotional status of user, etc. In an exemplary embodiment, a “decision tree” or even a “look-up-table” may be pre-installed (e.g., as a software module) in the apparatus 40. However, in some embodiments, more complex pattern recognition algorithms embodied in software, hardware or combinations thereof, may be employed. As indicated above, user interaction may be used as a factor or may actually specifically select the scenario in some cases.

Stroke or sketch detection may form another operation in some embodiments as shown by operation 110 of FIG. 4. Although operation 110 could follow operation 100, in alternative embodiments, the ordering could be switched or such operations may be performed at least partially simultaneously. During stroke detection, the touch of finger, stylus or other implement making a stroke on the touch screen is detected. In some cases, the parameters of the stroke/sketch are also determined (e.g., via the sensor 72) and used for analysis and mapping to pre-defined drawing patterns. The parameters may include but not be limited to the (x,y) coordinates of each sampling point, the sampling time interval, the pressure of the touch, the tilt of the stylus/pen, etc.

Sketch analysis may be performed at operation 120. During sketch analysis, the sensed stroke/sketch, in the form of the sensed parameters, may be analyzed with the support of pattern recognition technology. Due to selection of a specific scenario by operation 100, a table of codes of drawing patterns may be determined. Thus, for example, a subset of drawing patterns that are candidates for appearance in the selected scenario may be determined. For instance, if there are six typical drawing patterns (such as pine, aspen, flower, grass, cloud, and wind) corresponding to the scenario “country field”, the sketch analysis operation may recognize that the input stroke used maps to a corresponding one of the six drawing patterns (e.g., the pine tree of FIG. 3). Any suitable pattern recognition algorithm can be employed. Some examples include HMM (hidden markov model) and GLVQ (generalized local vector quantization) algorithms.

At operation 130, drawing pattern matching may be accomplished. Drawing pattern matching may include a determination of the type or class of drawing pattern that corresponds to the input stroke. To maximize the drawing effect, some variation on the standard drawing patterns may be introduced. For example, different people may not want to draw a pine always in the same form each time. As such, minor variations may be introduced to make the final result look more original. Accordingly, for example, a sensed sketch parameter such as the directional information of a stroke (shape), the length, the pressure, the tilt, or other factors, can make a predictive variation on the standard drawing patterns. In this regard, for example, a touch with intense pressure can make a local darker color effect. A different tilt (e.g., angle between the stylus and the touch screen) may make different line thickness and, in some cases, length of the stroke may influence various shape variations. In an exemplary embodiment, the pattern mapper 64 may be configured to implement predictive variations to basic output graphics based on predefined instructions.

In some cases, stroke events or input gestures may be associated with more complex inputs. For example, in some embodiments, the input analyzer 62 may be configured to recognize timing parameters with respect to input gestures and associate such timing parameters with an animation gesture input at operation 140. In this regard, for example, an input gesture having characteristics associated with a pre-defined time interval, a specific direction, a specific length and/or other dynamic property may be recognized as an animation gesture input and thus the corresponding output graphic may include animation selected to correspond therewith.

After determining a pattern corresponding to the determined stroke event, the pattern mapper 64 may render a corresponding pattern, drawing, animation, symbol or other graphical output at operation 150. In this regard, for example, the matched drawing patterns determined based on the predictive model 70 may be rendered (e.g., at the touch screen display 50). If there is animation gesture input detected, the animation effect may also be rendered. In this regard, for example, the stroke event that initiated the operation of the pattern mapper 64 may disappear automatically (e.g., after a fixed time interval), and the stroke event may be replaced by a selected pattern, symbol, image, animation or other graphical output as determined by the pattern mapper 64.

As indicated above, the service platform 20 may provide support or other services associated with embodiments of the present invention. However, some embodiments may require no input at all from the service platform 20 such that the apparatus 40 may operate independently at a mobile terminal or other device. In cases where the service platform 20 is utilized, the service platform 20 may enable sharing of drawing patterns, associations with particular scenarios, or other information among multiple different users. As such, for example, database management for scenarios and associations may, in some cases, be at least partially an Internet-based mobile activity. The service platform 20 may provide a basic set of associations/mappings for use by a local pattern mapper and the local pattern mapper may thereafter customize the associations/mappings and/or continuously update the associations/mappings based on the user's activities. Thus, for example, the local pattern mapper may be configured to use a basic starting map of stroke events to corresponding graphic outputs for certain predetermined scenarios, but may then learn the users habits and/or explicit desires in order to update mappings based on the user's activities.

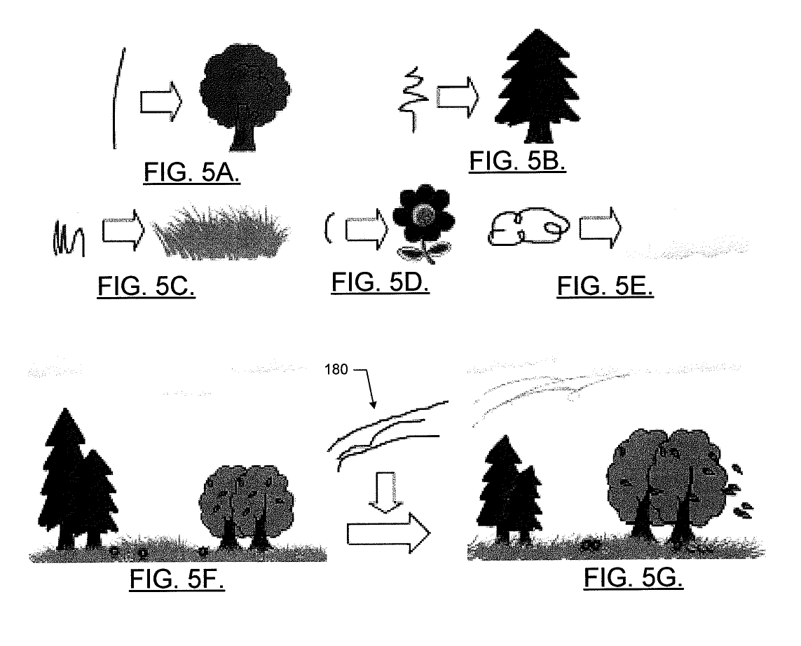

FIG. 5 (including FIGS. 5A through 5G) shows some examples of associations between particular stroke events and corresponding graphic outputs that may be provided by embodiments of the present invention in order to modify (or complete) a drawing (shown in FIG. 5G). In this regard, for example, a long vertical line may be mapped to a particular type of tree for the current scenario as shown in FIG. 5A. Meanwhile, a vertical line terminating in a zig-zag pattern may be mapped to a different type of tree for the same scenario as shown in FIG. 5B. As shown in FIG. 5C, grass may be mapped to horizontally oriented zig-zag patterned strokes and a curved line may map to a flower (FIG. 5D), while curved lines forming a closed shape approximating a cloud may be mapped to a cloud graphic (FIG. 5E) for the current scenario (e.g., country field). A drawing showing all of the features individually entered as described above in connection with FIGS. 5A through 5E may be displayed to the user as shown in FIG. 5F. If the user desires yet further modification of the drawing, a series of lines 180 may be entered to provide an image of wind to supplement the drawing as shown in FIG. 5G.

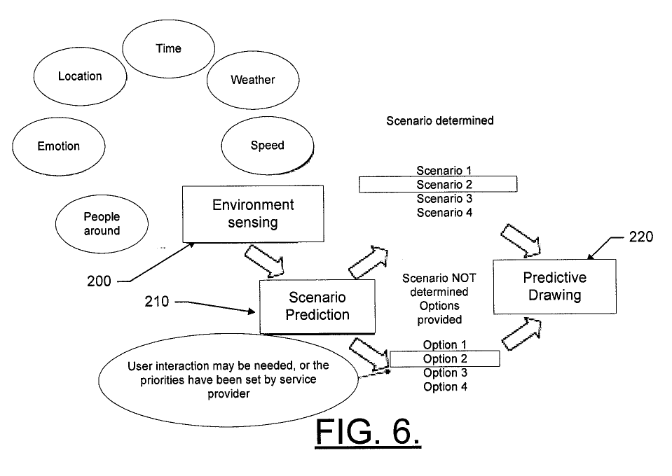

FIG. 6 shows another example of operation of an embodiment of the present invention. In this regard, as shown in FIG. 6, a determination of the current scenario may not always be made. In such cases, some embodiments may provide for various options to be provided to the user. In the example of FIG. 6, various parameters may be sensed by environmental sensing at operation 200 to enable scenario prediction at operation 210. If a particular scenario can be determined, predictive drawing 220 may be accomplished based on the scenario determined and the stroke event received from the user. However, if a scenario is not or cannot be determined, the user may be provided with different options for selecting a suitable scenario from among candidate scenarios or even for defining a new scenario. A determination as to which candidate scenarios to present as options may be made based on user preferences or priorities set by a service provider associated with the service platform 20. After presentation of options is made to the user, the user may select one of the options and predictive drawing 220 may thereafter be conducted based on the scenario associated with the selected option. In some cases, the scenario selector 74 may be updated accordingly based on the user's selection. As such, the scenario selector 74 may learn new scenarios or learn to better determine scenarios for selection based on user interaction when a scenario could not otherwise initially be determined.

Accordingly, some embodiments of the present invention provide a mechanism for enabling scenario based predictive drawing assistance. Furthermore, by using the random feature, amusing visual content may be created by random associations with stroke events received. Additionally, some embodiments provide flexibility in that such embodiments may learn, based on user behavior, to make new associations of specific identified stroke events with corresponding drawings under certain circumstances. As such, at least some embodiments (e.g., via a processor configured to operate as described herein) provide an ability to transform a physical touch event, represented on a display as a trace of pixels corresponding to movement of a writing implement, into a corresponding drawing that is selected based on the characteristics of the touch event itself and also the environmental situation or context in which the touch event was received. The drawing is then displayed to provide a completed drawing (or drawing element) in response to a relatively minimal input by using a trained and updatable predictive model.

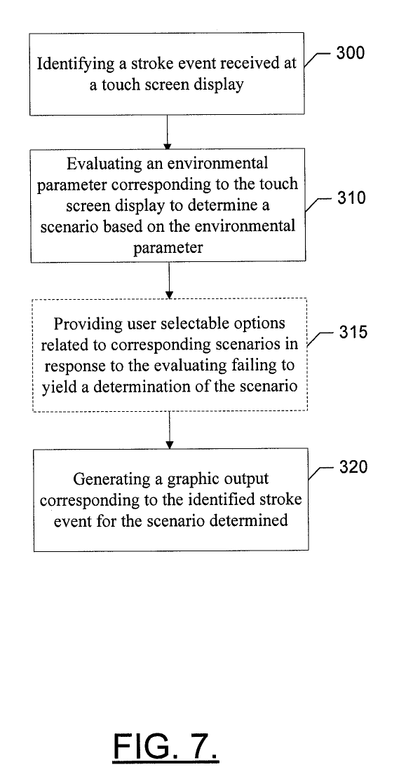

FIG. 7 is a flowchart of a system, method and program product according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, in an example embodiment, the computer program instructions which embody the procedures described above are stored by a memory device (e.g., memory device 58) and executed by a built-in processor (e.g., the processor 52). As will be appreciated, any such computer program instructions may be loaded onto a computer or other programmable apparatus (i.e., hardware) to produce a machine, such that the instructions which execute on the computer or other programmable apparatus create means for implementing the functions specified in the flowchart block(s) or step(s). In some embodiments, the computer program instructions are stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that one or more blocks or steps of the flowchart, and combinations of blocks or steps in the flowchart, can be implemented by special purpose hardware-based computer systems which perform the specified functions or steps, or combinations of special purpose hardware and computer instructions.

In this regard, one embodiment of a method for providing a predictive model for a touch screen display as provided in FIG. 7 may include operation 300 of identifying a stroke event received at a touch screen display. The method may further include evaluating an environmental parameter corresponding to the touch screen display to determine a scenario based on the environmental parameter at operation 310. Notably, operations 300 and 310 may be performed in any order. The method may further include generating a graphic output corresponding to the identified stroke event for the scenario determined at operation 320.

In some embodiments, the method may include further optional operations, an example of which is shown in dashed lines in FIG. 7. Optional operations may be performed in any order and/or in combination with each other in various alternative embodiments. As such, the method may further include providing user selectable options related to corresponding scenarios in response to the evaluating failing to yield a determination of the scenario at operation 315.

In some embodiments, certain ones of the operations above may be modified or further amplified as described below. It should be appreciated that each of the modifications or amplifications below may be included with the operations above either alone or in combination with any others among the features described herein. In this regard, for example, identifying the stroke event may include evaluating characteristics of a touch screen input relative to a set of predetermined characteristics of corresponding known inputs. In some cases, evaluating the environmental parameter includes receiving parameters from a sensor associated with the touch screen display and referencing a predetermined association between the parameters received and a corresponding scenario. In some embodiments, generating the graphic output includes erasing the stroke event from the touch screen display and providing a selected graphical element having an association with the stroke event and the scenario determined. In an exemplary embodiment, generating the graphic output includes generating an animation selected based on the determined scenario and triggering characteristics associated with the stroke event.

In an exemplary embodiment, an apparatus for performing the method of FIG. 7 above may comprise a processor (e.g., the processor 52) configured to perform some or each of the operations (300-320) described above. The processor may, for example, be configured to perform the operations (300-320) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 300-320 may comprise, for example, the processor 52, the input analyzer 62 (e.g., as means for identifying a stroke event received at a touch screen display), the scenario selector 74 (e.g., as means for evaluating an environmental parameter corresponding to the touch screen display to determine a scenario based on the environmental parameter), the pattern mapper 64 (e.g., as means for generating a graphic output corresponding to the identified stroke event for the scenario determined), and/or an algorithm executed by the processor 52 for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
identifying a stroke event received at a touch screen display;
evaluating an environmental parameter corresponding to the touch screen display to determine a scenario based on the environmental parameter; and
generating a graphic output corresponding to the identified stroke event for the scenario determined.

2. The method of claim 1, wherein identifying the stroke event comprises evaluating characteristics of a touch screen input relative to a set of predetermined characteristics of corresponding known inputs.

3. The method of claim 1, wherein evaluating the environmental parameter comprises receiving parameters from a sensor associated with the touch screen display and referencing a predetermined association between the parameters received and a corresponding scenario.

4. The method of claim 1, wherein generating the graphic output comprises erasing the stroke event from the touch screen display and providing a selected graphical element having an association with the stroke event and the scenario determined.

5. The method of claim 1, wherein generating the graphic output comprises generating an animation selected based on the determined scenario and triggering characteristics associated with the stroke event.

6. The method of claim 1, further comprising providing user selectable options related to corresponding scenarios in response to the evaluating failing to yield a determination of the scenario.

7. A computer program product comprising at least one computer-readable storage medium having computer-executable program code instructions stored therein, the computer-executable program code instructions comprising:
program code instructions for identifying a stroke event received at a touch screen display;
program code instructions for evaluating an environmental parameter corresponding to the touch screen display to determine a scenario based on the environmental parameter; and
program code instructions for generating a graphic output corresponding to the identified stroke event for the scenario determined.

8. The computer program product of claim 6, wherein program code instructions for identifying the stroke event include instructions for evaluating characteristics of a touch screen input relative to a set of predetermined characteristics of corresponding known inputs.

9. The computer program product of claim 6, wherein program code instructions for evaluating the environmental parameter include instructions for receiving parameters from a sensor associated with the touch screen display and referencing a predetermined association between the parameters received and a corresponding scenario.

10. The computer program product of claim 6, wherein program code instructions for generating the graphic output include instructions for erasing the stroke event from the touch screen display and providing a selected graphical element having an association with the stroke event and the scenario determined.

11. The computer program product of claim 6, wherein program code instructions for generating the graphic output include instructions for generating an animation selected based on the determined scenario and triggering characteristics associated with the stroke event.

12. The computer program product of claim 6, further comprising program code instructions for providing user selectable options related to corresponding scenarios in response to the evaluating failing to yield a determination of the scenario.

13. An apparatus comprising a processor configured to:
identify a stroke event received at a touch screen display;
evaluate an environmental parameter corresponding to the touch screen display to determine a scenario based on the environmental parameter; and
generate a graphic output corresponding to the identified stroke event for the scenario determined.

14. The apparatus of claim 13, wherein the processor is configured to identify the stroke event by evaluating characteristics of a touch screen input relative to a set of predetermined characteristics of corresponding known inputs.

15. The apparatus of claim 13, wherein the processor is configured to evaluate the environmental parameter by receiving parameters from a sensor associated with the touch screen display and referencing a predetermined association between the parameters received and a corresponding scenario.

16. The apparatus of claim 13, wherein the processor is configured to generate the graphic output by erasing the stroke event from the touch screen display and providing a selected graphical element having an association with the stroke event and the scenario determined.

17. The apparatus of claim 13, wherein the processor is configured to generate the graphic output by generating an animation selected based on the determined scenario and triggering characteristics associated with the stroke event.

18. The apparatus of claim 13, wherein the processor is further configured to provide user selectable options related to corresponding scenarios in response to the evaluating failing to yield a determination of the scenario.

19. An apparatus comprising:
means for identifying a stroke event received at a touch screen display;
means for evaluating an environmental parameter corresponding to the touch screen display to determine a scenario based on the environmental parameter; and
means for generating a graphic output corresponding to the identified stroke event for the scenario determined.

20. The apparatus of claim 19, further comprising means for providing user selectable options related to corresponding scenarios in response to the evaluating failing to yield a determination of the scenario.
